(19) United States
(12) Patent Application Publication
(10) Pub. No.: US 2006/0253304 A1
(43) Pub. Date: Nov. 9, 2006

(54) Providing an independent practitioner medical opinion via a network

(76) Inventor: Patricia H. David, Lewis Center, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/124,873

(22) Filed: May 9, 2005

(51) Int. Cl. G06F 19/00

(52) U.S. Cl. 705/3

(57) ABSTRACT

A system and method of providing a medical opinion prepared by an independent practitioner using a networked computer system where the opinion is related to issues regarding certain medical claims are described.

### FIELD OF THE INVENTION

The present invention relates generally to the transfer of medically-related information between computers connected in a network and more specifically to the transfer of claim-related information requested via the Internet.

### BACKGROUND OF THE INVENTION

Workers are covered by federal and state laws for medically related matters. Laws, such as those relating to worker's compensation, the Family and Medical Leave Act (“FMLA”), and American Disability Act, require the worker to submit a claim for restrictions on work-related activities, a leave of absence, termination, and the like. Under these laws, an employer may require the worker to obtain an independent medical examination (“IME”) from a health care provider to determine whether the worker's claim is valid. An IME is an impartial opinion to help determine cash, medical, and/or rehabilitation benefits for claims' cases.

Claims administrators are charged with determining the issues regarding a claim. Most claims administrators are non-physician professionals and require a physician's opinion to complete the determination of validity. Administrators look for different things in requesting an IME; therefore, in order to deliver an IME, the physician performing the IME must know the criteria and context of the administrator's request. Typical issues in most IME's are: diagnosis, causal relationship, prognosis, maximum medical improvement, percent impairment rating, work capability, appropriateness of care, and recommendations with possible functional capacity assessments. Specific issues, such as causality of injury or illness, a return to work status, and or the claimant's impairment rating may be determined through an IME. Efficacy of treatment and the time frames for medical recovery are also typically addressed in an IME.

In some cases an IME is required. While some administrators have access to staff that can provide them with medical guidance, many organizations, due possibly to the cost of covering salary and benefits, do not have a staff physician. Even if an organization does have access to a staff physician, the opinion may not be considered to be sufficiently “independent” in that the staff physician is an employee of, and may be loyal to, the organization.

In cases where an IME is optional, because they typically cost over about $200 or more, an administrator may want guidance to help determine the direction of a claim prior to proceeding with a full, formal IME or file review. Currently, no quick, easy, inexpensive system is in place that allows a requestor access to an independent physician to illuminate one or more issue pertinent to a claim. A method and system are needed to provide a claim administrator with guidance as to whether to proceed with an IME or file review from a physician on an as needed basis without incurring the costs of a full-time, staff physician.

### SUMMARY OF THE INVENTION

The present invention provides online guidance to requesters as to whether to proceed with an IME or file review. The present invention is a system of using a networked communication device to electronically access a practitioner to obtain an opinion from an independent source for guidance on an issue related to a worker's claim. The system provides a user an opinion without having to incur the expense of a full, formal IME or file review.

The present invention provides a method of using a system for requesting a medical opinion prepared by a practitioner. The opinion is related to an issue regarding a medically-related claim. The method comprises: 1) providing a processor connected to an electronic network; 2) receiving a user's request for the opinion; 3) generating a record generated from the request to be stored in a database connected to the processor; 4) optionally receiving additional information related to the claim; 5) transmitting the request to the practitioner, who reviews the user's request and any additional information in order to prepare the opinion; 6) adding the opinion to the record; 7) storing the record in the database; and 8) providing access to the opinion. The request comprises data inputted by the user using a communication device connected to the network. The data comprises: a) user-related information comprising means to contact the user; b) issue-related information; and c) claim-related information.

The present invention and its advantages and uses will become apparent from the following description taken in conjunction with the accompanying drawings. The drawings constitute a part of the specification of the invention, which includes exemplary embodiments of the present invention and illustrate various objects and features thereof.

### BRIEF DESCRIPTION OF THE DRAWINGS

FIG. 1 illustrates the concept of the functional modules of the system in an embodiment of the present invention.

FIG. 2 is a block diagram of the method of present invention.

FIG. 3 is a representative screen capture of the graphic user interface of the present invention.

### DETAILED DESCRIPTION OF THE INVENTION

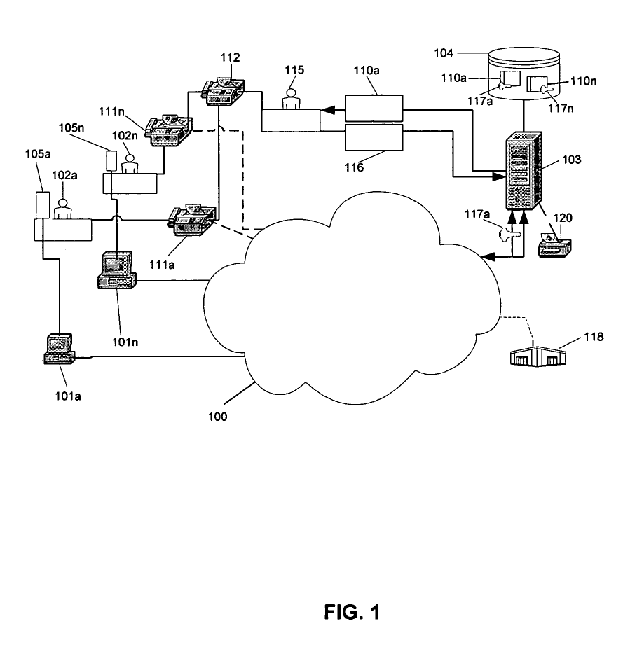

FIG. 1 illustrates an environment in which the present invention may be implemented. The system of the present invention is initiated by a user 102a-n who has access to a publicly accessible, electronic network 100 operatively coupling input devices 101a-n associated with users 102a-n to the network 100. The network 100 may be any communication network that. allows data transmission/reception, such as but not limited to an intranet, a LAN, a WAN, the Internet, a system of interconnected communication devices, and the like. Users 102a-n of the present invention include but are not limited to 1) physicians interested in obtaining occupational medicine second-opinion consultation; 2) attorneys and paralegals; 3) claims examiners and claims adjusters; 4) case managers; 5) workers' compensation administrators; 6) human resource managers and representatives; and 7) any other person or entity charged with determining the issues regarding a medically-related claim made by an individual.

Users 102a-n access a processor 103 connected to the network 100. The processor 103 is interconnected to a database 104. The processor 103 provides the user 102a with an interface 105a-n for the user 102a to input data associated with a claim to request a medical opinion regarding an issue related to the claim. The processor 103 receives the data inputted by the user 102a to create a record 110a-n from the inputted data. The processor 103 notifies a practitioner 115 each time a record 110a is created. The practitioner 115 reviews the record 110a and prepares an opinion 116 related to the request in the record 110a.

Optionally, a user 101a may transmit additional information to the practitioner 115 using a second device 111a-n. The second device 111a-n is a data transmission or communication device, such as but not limited to a facsimile machine, computer capable of e-mail transmission, telegraph, teletype, postal delivery, telephone, courier, hand delivery and the like. The second device may be connected to the processor 103 via the network 100 or a second network. The practitioner 115 may refer to the additional information to prepare the opinion 116.

The processor 103 adds the opinion 116 to the record 110a and stores the record 110a in the database 104. The processor optionally generates a key 117a-n associated with each record 110a-n. The key 117a is a security procedure, which may be in the form of a sign-on protocol that requires a user name and password or any other digital or biometric security object. The processor 103 accesses the network 110 and transmits the key 117a to the user 102a using transmission-specific data inputted by the user 102a, such as, but not limited to, the user's email, postal address, telephone number, facsimile number, and the like. The processor 103 may also add a billing notice charged by the practitioner 115 for preparing the opinion 116 to the record 110a. Alternatively, the billing notice may be transmitted to the user 102a either through the network or through any other transmission means.

In an alternative embodiment, the system comprises a printer 120 connected to the processor. The printer 120 is used to print billing notices, reports, requests, opinions for hand signature, and the like. The opinion and billing notice may be sent to the user via the post office, a facsimile machine, a scanner, and the like.

In an embodiment, the transmission-specific data is the user's e-mail address. The user 102a accesses the network 100 and receives the e-mail transmitted from the processor 103. The user 102a, again accesses the processor 103 using information contained in the e-mail message. The processor 103 activates the interface 105a for use by the user 102a. The user 102a inputs the key 117 using the interface 105a-n. The processor 103 matches the key 117a to the record 110a and posts the opinion 116 at the interface 105a.

In an embodiment, opinion pricing information is provided to the user 102a. Pricing information may be provided by conventional means or through the interface 105a. In an embodiment, the user is provided pricing information upon access to the processor 103 through the interface 105a. In an embodiment, pricing is based on an hourly rate. In an embodiment, pricing is an hourly rate based on $25 for every 6 minutes spent by the practitioner to review the inputted data and or additional information and prepare the opinion.

After requesting an opinion, the user 102a may receive a billing notice through the network 100, through conventional means, or through other means, such as but not limited to a credit service 118 interconnected to the network 100. The credit service 118 may be part of a publicly accessible service maintained by a bank or other electronics funds transfer facility or institution, such as those run by major credits cards. The credit service 118 comprises the appropriate applications and database software for conducting electronic financial transactions. In an embodiment, a user 102a receives billing upon accessing the processor 103 to obtain the opinion.

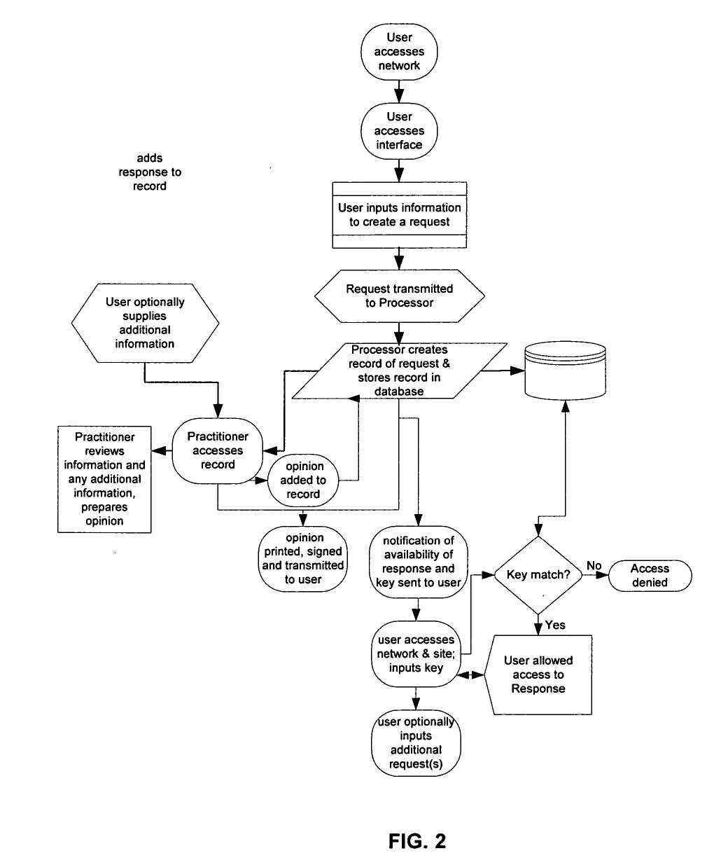

An embodiment of a use of the system of the present invention is depicted in FIG. 2. To obtain a medical opinion prepared by an independent practitioner in response to a request to review an issue related to a claim, a user, using a communication device, accesses a processor connected to an electronic network. In an embodiment, a user is a medical professional, a legal professional, a claims examiner, a claims adjuster, a case manager, workers' compensation administrator, a human resource manager/representative, and the like.

The user creates a request for the medical opinion by transferring data to the processor. In an embodiment, the data comprises user-related information, issue-related information, and claim-related information. In an embodiment, the request comprises a claimant last name, a claimant first name, a claim number, a date of injury, an employer, at least one allowed or alleged condition; a summary of the claim, at least one issue for review, a referral source, user 1) name, 2) telephone, 3) e-mail, a party responsible for payment of a billing associated with the opinion, and the like. In an embodiment, claim-related information comprises medical information related to a claim made under 1) worker's compensation, 2) the Family and Medical Leave Act, 3) the Americans with Disabilities Act, 4) short-term/long-term disability coverage and other related programs. In an embodiment, issue-related information is information related to diagnosis, causal relationship, prognosis, maximum medical improvement, percent impairment rating, work capability, appropriateness of care, functional capacity assessment, return to work status, and the like.

The processor generates a record from the data to be stored in a database connected to the processor and transmits the request to the practitioner. It is to be understood that the records described may be stored in one or more database, or, alternatively, in a redundant, distributed or remote access manner without parting from the spirit and scope of the invention described herein. Similarly, the data and methods associated with any single record may be further divided into sub classes to achieve the same results as those described herein.

The practitioner reviews the user's request and prepares the medical opinion. Optionally, the user supplies the practitioner with additional information that the practitioner uses to prepare the opinion. The additional information may be received via the network or a second communication tool. In an embodiment, the additional information is a medical examination report, such as but not limited to x-ray report, a magnetic resonance image report, a computed tomography scan report, an electrocardiogram report, and an electroencephalogram report, a laboratory analysis, an eye exam report, hearing exam report, and the like. In an embodiment, the additional information is a diagnostic study report, such a videotape or other report, a claimant history, and the like.

The practitioner uses the processor to add the opinion to the record where it is available for access by the user. Access is provided by electronic or conventional means. In an embodiment, the processor generates a key associated with the record and transmits the key to the user. In an embodiment, user-related information comprising an e-mail address. The key is transmitted to the user in an e-mail addressed using the inputted user e-mail address.

Upon receipt of the system's e-mail message, the user accesses the processor again using the information in the transmission and inputs the key through the interface to the processor. In an embodiment, the key is a password associated with the user's name. The processor performs a look up on the key and provides a record associated with the key to the user through the interface. Where no match is found, no opinion is provided. Alternatively, the opinion is printed using the printer 120, signed by the practitioner, and transmitted to the user. A billing notice may be provided with the opinion. The billing notice may be provided electronically or through conventional means, such as mailing, hand delivery, etc.

In an embodiment, the request comprises a date and the opinion is added to the record within 24 hours of the date.

In an embodiment, the user may input an additional request. The additional request may be a follow-up question, a new request, a request relating to another issue, a request for an IME and the like.

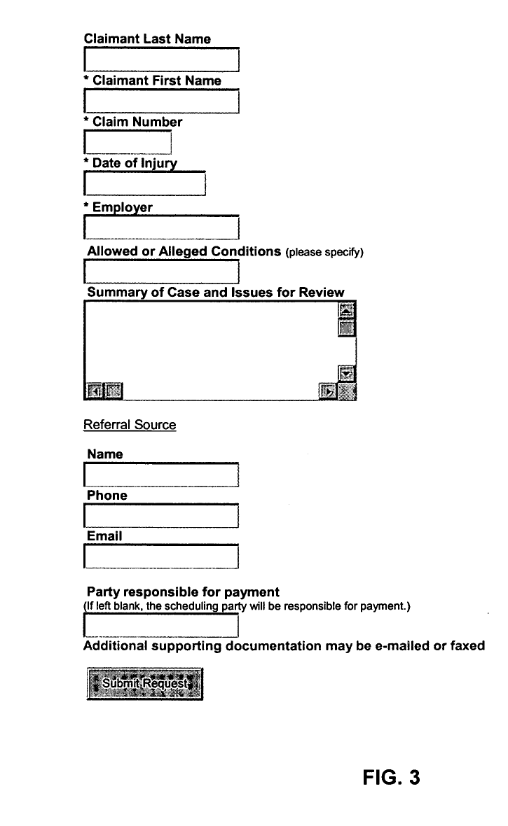

In an embodiment, the user, via the Internet, accesses a web site created by the processor associated with a URL. The web pages at the site contain hyperlinks that allow the user 102a to navigate the site. The processor 103 presents web pages to the user 102a and controls the flow of information to and from the database 104. Inn an embodiment, the interface 105a is a specific web page comprising an interactive form (an embodiment of which is illustrated in FIG. 3) for use by the user 102a to input information. The information comprises demographic and contact information, a brief history of a questioned claim and an issue to be addressed. The user inputs information into the form electronically. In an embodiment, the form comprises prompted fill-in type input areas. In an embodiment depicted in FIG. 3, the fill-in areas include Claimant Last Name, Claimant First Name, Claim Number, Date of Injury, Employer, Allowed or Alleged Conditions; Summary of Case and Issues for Review, Referral Source, Name, Phone and Email of the user and the Party responsible for payment.

Through the interface, the user 102a specifies the allowed or alleged condition(s) associated with the claim. After inputting the information the user 102a submits the request. In and embodiment depicted in FIG. 3, the user submits the request by clicking “Submit Request.”

The system delivers the request to the practitioner via a communication device connected to the network 100, such as any computer, PDA, cell phone, scanner, or like device. The practitioner views the inputted information and prepares an opinion regarding the request. In an embodiment, the practitioner prepares an opinion based on the inputted information and transmits the opinion to the processor. In an embodiment, the opinion is made available within a given period, such as, in the preferred embodiment, 24 hours from the date of the request.

In an embodiment, the opinion is written on the practitioner's letterhead and bears the practitioner's signature. In an embodiment, the opinion bears a physician's signature and is able to be filed with the Bureau of Worker's Compensation and or be used at a hearing if the user determines either is appropriate. In an alternate embodiment, the opinion is posted on a secure, password protected site located on the on the network 100. A user accesses the site using an assigned login and password to obtain the opinion electronically. The user then uses the opinion to determine the direction of the claim. A user may optionally request additional information.

The system further comprises a mechanism to generate a request status report and an opinion delivery report showing detailed information on request status from pending request to payment of the billing notice.

No treatment recommendations and or advice directly to patients and or claimants are provided via the system. No doctor-patient relationship is established. Opinions using the system are provided only to third parties who are associated with the administration of a claim.

The following examples are provided to further illustrate the system. In each of the examples, the cost of the opinion was less than $100:

### EXAMPLE 1

In a case, a worker alleged a fractured a foot bone from jumping off an 18-inch stool at work. A user, an attorney wanted to determine whether the injury was medically plausible, but the worker's employer did not want to incur the expense of an IME or file review. The attorney submitted a case summary by completing the online form. The attorney included the question as to whether a foot bone could fracture from jumping off an 18-inch stool. The employer sent a facsimile of the x-ray report of the fracture to the physician's office associated with the system. The physician evaluated the summary and the report and prepared a written opinion for the attorney and the employer.

### EXAMPLE 2

An employee alleged carpal tunnel syndrome as a result of work activity. The employee's employer was unsure if the syndrome could result from the work activity, but did not want to incur the expense of an IME. The employer submitted a case summary and the question using the online and delivered a videotape of the employee's work activities to the physician's office associated with the system of the invention. The physician determined from the summary and video that the alleged condition was likely related to the employee's work activities. The cost to oppose a claim that was in fact medically probable was avoided.

### EXAMPLE 3

An employee submitted a FMLA request for seasonal allergies. The employee's physician categorized the employee's condition as a “serious health condition.” The employee's employer questioned the FMLA request and submitted a question using the online form. The physician associated with the system of the invention evaluated the question and posted an opinion that the employer retrieved using a password from a secured website.

### EXAMPLE 4

An employee submitted a worker's compensation claim claiming asbestosis. The employee had machined a product containing asbestos several years earlier. The machining took approximately one week. The attorney for the case submitted an online form asking whether it was plausible that a one week exposure to asbestos could cause asbestosis and whether exposure to other substances could cause asbestosis. The physician associated with the system of the invention evaluated the question and posted an opinion that the attorney retrieved using a password from a secured website.

### EXAMPLE 5

An employee was driving a semi tractor trailer that was rear-ended by another truck. The employee's cab flipped. The employee sustained injuries including a concussion, a sprained lumbar an neck, neurocardiogenic syncope, and contusions to his head as well as to his left lower leg. The employee now has occipital headaches, dizziness, and looses consciousness without warning. The attorney and the employee's employer used the online form to request an opinion as to whether the employee was seeing the right kind of doctor for his condition and whether he was receiving the correct treatment. The physician associated with the system of the invention evaluated the question and posted an opinion that the attorney retrieved using a password from a secured website.

### EXAMPLE 6

An employee claimed FMLA due to fibromyalgia. The employee's physician categorized the claim as a “serious health condition.” The employee's employer used the online form of the system of the invention to question the FMLA request. The physician associated with the system of the invention evaluated the question and posted an opinion that the employer retrieved using a password from a secured website.

### EXAMPLE 7

An employee was involved in a motor vehicle accident while commuting from one worksite to another. A post-accident drug test was positive for four controlled substances. The employee had no prescription for any of the substances. The employee's employer used the online form of the system of the invention to question the causal relationship between the controlled substances and the motor vehicle accident. The physician associated with the system of the invention evaluated the question and posted an opinion that the employer retrieved using a password from a secured website.

### EXAMPLE 8

An employee alleged strain of the round ligament of the uterus due to standing at work. The employee was pregnant at the time of the alleged injury; however, the injury was not reported until a year after the alleged incident, after the employee had given birth. The employee's employer used the online form of the system of the invention to question whether the strain could have been caused by standing. The physician associated with the system of the invention evaluated the question and posted an opinion that the employer retrieved using a password from a secured website.

### EXAMPLE 9

An employee sustained a tibial plateau fracture as a result of a work-related injury. The employer accepted the claim. Following treatment and immobilization by the orthopedic surgeon, the employee was placed off work. The employer had a restricted duty program structured to accommodate a wide variety of restrictions. The employee's employer used the online form of the system of the invention to question whether the employee was capable of performing some form of restricted duty work, and asked for specific restrictions. The physician associated with the system of the invention evaluated the question and posted an opinion that the employer retrieved using a password from a secured website.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

What is claimed is:

1. A method of providing a medical opinion, said opinion prepared by an independent practitioner reviewing an issue related to a claim, the method comprising:
providing a processor connected to an electronic network;
receiving a user's request for the medical opinion, said request comprising data input by the user using a communication device connected to the network; said data comprising user-related information, issue-related information, and claim-related information; said request transmitted though the network to the processor;
generating a record to be stored in a database connected to the processor, said record generated from the request;
transmitting the request to the practitioner, said practitioner reviewing the user's request and preparing the opinion;
adding the opinion to the record; and,
providing the user access to the opinion.

2. The method of claim 1 wherein the providing of access to the opinion is provided by the processor:
generating a key associated with the record, said key comprising means to access the record;
transmitting the key to the user;
receiving the key from the user;
matching the key to the record; and
providing access to the record based upon the match.

3. The method of claim 1 wherein access to the opinion is provided by transmitting the opinion to the user, said transmitted opinion comprising a handwritten signature of the practitioner.

4. The method of claim 1 wherein the claim-related information comprises medical information related to a claim made under 1) worker's compensation, 2) the Family and Medical Leave Act, 3) the Americans with Disabilities Act, and 4) short-term/long-term disability coverage.

5. The method of claim 1 wherein the request comprises a claimant last name, a claimant first name, a claim number, a date of injury, an employer, at least one allowed or alleged condition; a summary of the claim, at least one issue for review, a referral source, user 1) name, 2) telephone, 3) e-mail, and a party responsible for payment of a billing associated with the opinion.

6. The method of claim 1 wherein the user is one of a medical professional, a legal professional, a claims examiner, a claims adjuster, a case manager, a workers' compensation administrator and a human resource manager/representative.

7. The method of claim 1 wherein the issue-related information is at least one of diagnosis, causal relationship, prognosis, maximum medical improvement, percent impairment rating, work capability, appropriateness of care, functional capacity assessment, and return to work status.

8. The method of claim 1 comprising receiving additional information for review by the practitioner in preparation of the opinion, said additional information received by at least one of via the network and via a second communication tool.

9. The method of claim 8 wherein the additional information is at least one of a medical examination report, a diagnostic study report, and a claimant history.

10. The method of claim 9 wherein the additional information is one of a videotape, an x-ray report, a magnetic resonance image report, a computed tomography scan report, an electrocardiogram report, and an electroencephalogram report, a laboratory analysis, an eye exam report, and a hearing exam report.

11. The method of claim 1 wherein the request comprises a date and the opinion is added to the record within 24 hours of the date.

12. The method of claim 1 comprising adding a billing notice to the record; said billing notice provided to the user with the opinion.

13. A system for providing a medical opinion, said opinion prepared by an independent practitioner reviewing an issue related to a claim, the system comprising: a processor operatively connected to an electronic network and a database, said processor: 1) providing an interface connected to the processor for a user to request the opinion; 2) receiving data inputted by the user using the interface, said data comprising user-related information, issue-related information, and claim-related information; 3) creating a record from the inputted data; 3) notifying the practitioner that the record has been created; 4) receiving the opinion prepared by the practitioner; 5) adding the opinion to the record; 6) storing the record in the database; and 7) providing the user access to the opinion.

14. The system of claim 13 wherein providing access to the opinion comprises: the processor: 1) generating a key associated with the record; 2) accessing the network and transmitting the key to the user; 3) matching the key to the record upon input of the key by the user; and 10) allowing access to the opinion based on the match.

15. The system of claim 13 comprising a printer connected to the processor, said printer printing the opinion, said practitioner applying a handwritten signature to the opinion and transmitting the opinion to the user.

16. The system of claim 13 wherein the claim-related information comprises medical information related to a claim made under 1) worker's compensation, 2) the Family and Medical Leave Act, 3) the Americans with Disabilities Act, and 4) short-term/long-term disability coverage.

17. The system of claim 13 wherein the practitioner reviews additional information to prepare the opinion, said additional information received from the user transmitted by at least one of via the network and via a second communication tool.

18. The system of claim 17 wherein the additional information is at least one of a medical examination report, a diagnostic study report, and a claimant history.

19. The system of claim 13 wherein 1) additional information related to the claim is transmitted to the practitioner, said additional information at least one of a medical examination report, a diagnostic study report, and a claimant history, and the practitioner reviews the data and the additional information to prepare the opinion; 2) user-related information comprising at least one contact means; 3) issue-related information comprises at least one a diagnosis, a causal relationship, a prognosis, a maximum medical improvement, a percent impairment rating, a work capability, an appropriateness of care, a functional capacity assessment, and a return to work status; 4) claim-related information comprises at least one of a medical examination report, a diagnostic study report, and a claimant history; and 5) providing access is via one of a) printing the opinion by a printer connected to the processor and transmitting the opinion to the user, said transmitted opinion comprising a handwritten signature of the practitioner; and b) the processor i) generating a key associated with the record; ii) transmitting the key to the user using the user contact means; iii) matching the key to the record upon input of the key by the user; and iii) allowing the user access to the opinion based upon the match.

20. A method of using a system for providing a medical opinion prepared by a practitioner, said opinion related to an issue regarding a claim, the method comprising:
providing a processor connected to an electronic network;
receiving a user's request for the opinion, said request comprising data input by the user using a communication device connected to the network; said data comprising 1) user-related information comprising an e-mail address; 2) issue-related information selected from the group at least one a diagnosis, a causal relationship, a prognosis, a maximum medical improvement, a percent impairment rating, a work capability, an appropriateness of care, a functional capacity assessment, and a return to work status; and 3) claim-related information comprising a claimant history and at least one of a medical examination report and a diagnostic study report; said request transmitted though the network to the processor;
generating a record to be stored in a database connected to the processor, said record generated from the request;
receiving additional information related to the claim, said additional information at least one of a medical examination report, a diagnostic study report, and a claimant history;
transmitting the request to the practitioner, said practitioner reviewing the user's request and the additional information to prepare the opinion;
adding the opinion to the record;
storing the record in the database; and
providing access to the opinion; said providing means being one of a) printing the opinion by a printer connected to the processor and transmitting the opinion to the user, said transmitted opinion comprising a handwritten signature of the practitioner; and b) the processor 1) generating a key associated with the record; 2) transmitting the key to the user; 3) matching the key to the record upon input of the key by the user using the inputted user email address; and 4) allowing the user access to the opinion based upon the match.
